(19) United States
(12) Patent Application Publication
(10) Pub. No.: US 2013/0013678 A1
(43) Pub. Date: Jan. 10, 2013

(54) METHOD AND SYSTEM FOR IDENTIFYING A PRINCIPAL INFLUENCER IN A SOCIAL NETWORK BY IMPROVING RANKING OF TARGETS

(75) Inventor: Arvind MURTHY, Bangalore (IN)

(73) Assignee: Yahoo! Inc., Sunnyvale, CA (US)

(21) Appl. No.: 13/175,955

(22) Filed: Jul. 5, 2011

(51) Int. Cl. G06F 15/16

(52) U.S. Cl. 709/204

(57) ABSTRACT

A method and system for identifying a principal influencer in a social network by improving ranking of targets. The method includes determining a user connection graph for a plurality of users registered on the social network and classifying the users into one or more connection levels based on the user connection graph. A list of reviewers associated with each target of a plurality of targets in the social network is built. A reviewer connection graph is determined for the list of reviewers associated with each target. Based on the reviewer connection graph, one or more top reviewers are ranked for each target. The principal influencer is then identified from the list of reviewers associated with each target. The system includes electronic devices, a communication interface, a memory, and processor. The processor includes a user connection unit, a reviewer unit, and a ranking engine.

### TECHNICAL FIELD

Embodiments of the disclosure relate to the field of identifying a principal influencer in a social network by improving ranking of targets.

### BACKGROUND

Currently, networking websites are being widely used for creating connections or social relationships between multiple users. Some of the networking websites include a review and ranking platform that allow users to providing reviews and rankings for targets. Examples of the targets include, but are not limited to, products and services. The users can login to a networking website and rank a target. A user can take a decision, for example a decision to experience the target, based on the ranking of the target. However, such a ranking is not personalized to the user, in current systems, and the user can end up taking a wrong decision.

In the light of the foregoing discussion, there is a need for a method and system to identify a principal influencer in a social network, based on personalization of the ranking. Further, there is a need to improve ranking of the targets.

### SUMMARY

The above-mentioned needs are met by a method, a computer program product and a system for identifying a principal influencer in a social network by improving ranking of targets.

An example of a method of identifying a principal influencer in a social network by improving ranking of targets includes determining a user connection graph for a plurality of users registered on the social network. The method also includes classifying the plurality of users into one or more connection levels based on the user connection graph. The method further includes building a list of reviewers associated with each target of a plurality of targets in the social network. Further, the method includes determining a reviewer connection graph for the list of reviewers associated with each target of the plurality of targets. The method also includes ranking one or more top reviewers, based on the reviewer connection graph, for each target of the plurality of targets. Moreover, the method includes identifying the principal influencer from the list of reviewers associated with each target of the plurality of targets.

An example of a computer program product stored on a non-transitory computer-readable medium that when executed by a processor, performs a method of identifying a principal influencer in a social network by improving ranking of targets includes determining a user connection graph for a plurality of users registered on the social network. The computer program product also includes classifying the plurality of users into one or more connection levels based on the user connection graph. The computer program product further includes building a list of reviewers associated with each target of a plurality of targets in the social network. Further, the computer program product includes determining a reviewer connection graph for the list of reviewers associated with each target of the plurality of targets. The computer program product also includes ranking one or more top reviewers, based on the reviewer connection graph, for each target of the plurality of targets. Moreover, the computer program product includes identifying the principal influencer from the list of reviewers associated with each target of the plurality of targets.

An example of a system for identifying a principal influencer in a social network by improving ranking of targets includes one or more electronic devices, a communication interface, a memory, and a processor. The communication interface is in electronic communication with the one or more electronic devices. The memory stores instructions. The processor includes a user connection unit responsive to the instructions to determine a user connection graph for a plurality of users on the social network and to classify the plurality of users into one or more connection levels based on the user connection graph. The processor also includes a reviewer unit responsive to the instructions to build a list of reviewers associated with each target of a plurality of targets and to determine a reviewer connection graph for the list of reviewers associated with each target of the plurality of targets in the social network. The processor further includes a ranking engine responsive to the instructions to rank one or more top reviewers, based on the reviewer connection graph, for each target of the plurality of targets, to specify an overall rank for each user of the plurality of users on the social network, and to identify the principal influencer from the list of reviewers associated with each target of the plurality of targets.

The features and advantages described in this summary and in the following detailed description are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE FIGURES

In the following drawings like reference numbers are used to refer to like elements. Although the following figures depict various examples of the invention, the invention is not limited to the examples depicted in the figures.

FIG. 1 is a block diagram of an environment, in accordance with which various embodiments can be implemented;

FIG. 2 is a block diagram of a server for identifying a principal influencer in a social network by improving ranking of targets, in accordance with one embodiment;

FIG. 3 is a flowchart of a method for identifying a principal influencer in a social network by improving ranking of targets, in accordance with one embodiment; and

FIG. 4 is an exemplary representation of identification of a principal influencer in a social network, in accordance with one embodiment.

### DETAILED DESCRIPTION OF THE EMBODIMENTS

The above-mentioned needs are met by a method, computer program product and system for identifying a principal influencer in a social network by improving ranking of targets. The following detailed description is intended to provide example implementations to one of ordinary skill in the art, and is not intended to limit the invention to the explicit disclosure, as one or ordinary skill in the art will understand that variations can be substituted that are within the scope of the invention as described.

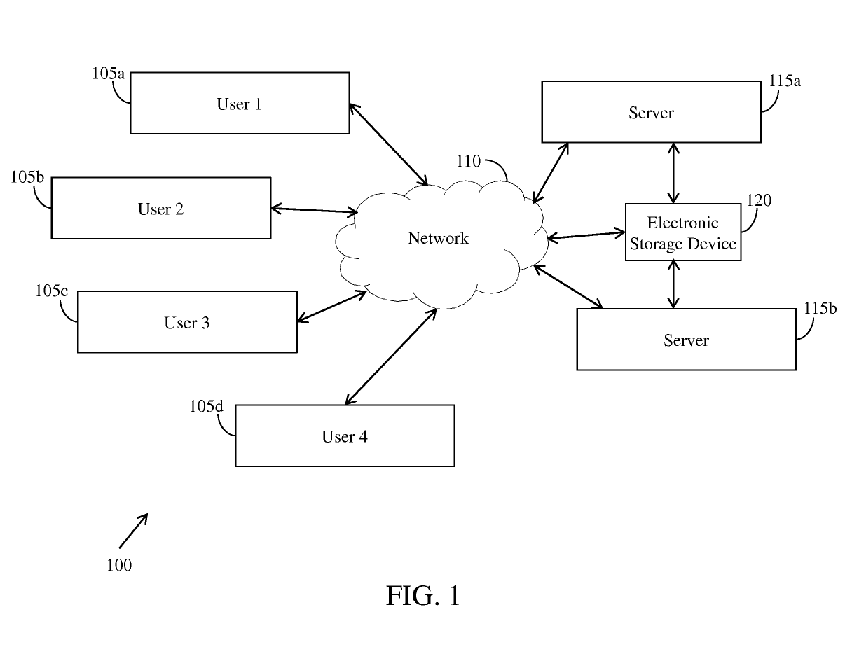

FIG. 1 is a block diagram of an environment 100, in accordance with which various embodiments can be implemented.

The environment 100 includes one or more users, for example a user 105a, a user 105b, a user 105c, and a user 105d. The environment 100 also includes a network 110, and one or more servers, for example a server 115a and a server 115b.

The server 115a and the server 115b are connected to the network 110. The server 115a and the server 115b are in electronic communication through the network 110 with the users. The users can be located remotely with respect to the server 115a and the server 115b. Examples of the network 110 include, but are not limited to, Ethernet, a Local Area Network (LAN), a Wireless Local Area Network (WLAN), a Wide Area Network (WAN), internet, and a Small Area Network (SAN).

The users of electronic devices can communicate with each other through the network 110. The server 115a or the server 115b is also in communication with an electronic device (not shown) of a user, for example the user 105a, via the network 110. The electronic device can be remotely located with respect to the server 115a or the server 115b. Examples of the electronic device include, but are not limited to, a desktop, a laptop, a hand held computer, a mobile device, a personal digital assistant (PDA), a smart phone, a digital television (DTV), an internet protocol television (IPTV), and a play station.

The server 115a and the server 115b are also connected to an electronic storage device 120 directly or via the network 110 to store information, for example a list of targets.

In some embodiments, different electronic storage devices are used for storing the information.

The users can establish different social relationships with each other, via a social network, based on one or more of friendship, kinship, common interest, financial exchange, and common beliefs. A social relationship can be established using a social structure of nodes and links. The nodes can represent the users connected to the network 110 and the links can represent the social relationship existing between the users.

The users can be grouped into a plurality of clusters based on different social relationships. The users from various clusters can also be connected to each other. The users can express different attributes, for example views, beliefs, relation, behavior, attitude, current status, ideas, and practices. A network analysis can be performed to identify the attributes associated with the users. Further, the users can chat with each other via the network 110.

The server 115a stores information associated with the users that are registered with the social network. The server 115a also stores connection details associated with each user. Further, the server 115a maintains a list of a plurality of targets along with user ratings for each target. The server 115a maps each of the user rating to a corresponding target. The user ratings associated with the target can be reviewed for taking decisions. The user ratings can also be utilized for marketing purposes by advertisers and promoters. The user ratings can be used to further identify a principal influencer in the social network.

In one example, the user 105a, the user 105b, the user 105c and the user 105d are connected to each other based on different connection levels in the social network. The user 105a can be interested in electronic gadgets and updates information associated with the electronic gadgets. The information that is updated is then displayed on the social network. The user 105b, the user 105c and the user 105d can be influenced by the information that is updated by the user 105a for making decisions associated with one or more of the electronic gadgets. In one example, the decisions can include buying the electronic gadgets.

In another example, if the user 105a has purchased a laptop then the user 105a can rank the laptop. Ranking can indicate quality of performance of the laptop as one of excellent, good, fair or bad. Similarly, multiple users can rank the laptop as desired. If the user 105b wishes to purchase the laptop then the user 105b can obtain feedback corresponding to the laptop from the user 105a. Further, the user 105b can utilize the ranking provided by the user 105a before taking a decision to purchase the laptop. The ranking provided by the user 105a bears an increased weightage since the user 105b is connected to the user 105a in the social network. The weightage is computed as a probability distribution based on user profile, proximity of the users, user profile of connected users, and target based attributes. Hence, the ranking provided by a connected user, for example the user 105a, is preferred when compared to the ranking provided by multiple users anonymous to the user 105b. Further, the ranking provided by the user 105a, connected to the user 105b, has a higher relevancy.

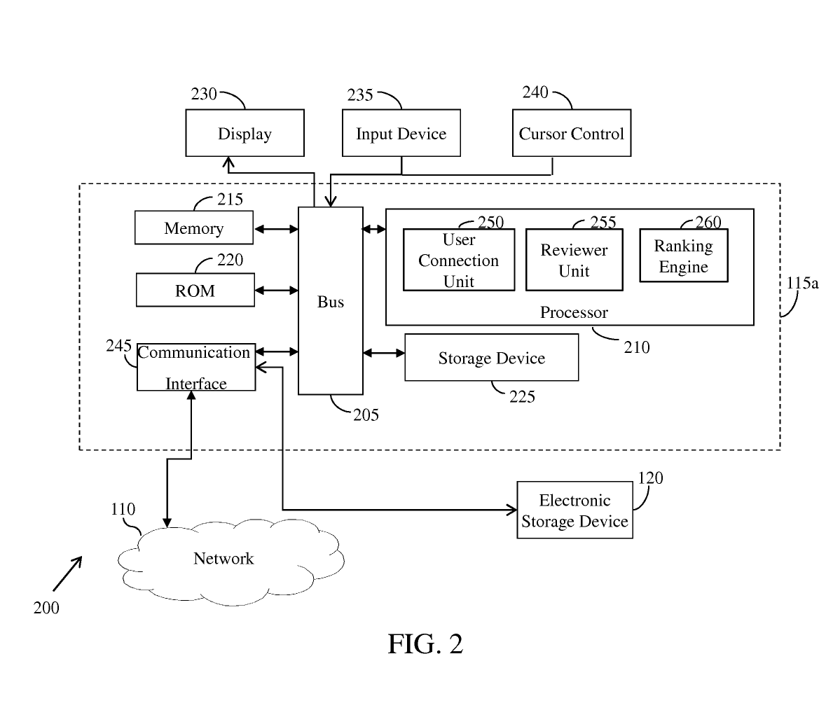

The server 115a including a plurality of elements is explained in detail in conjunction with FIG. 2.

FIG. 2 is a block diagram of the server 115a for identifying a principal influencer in a social network by improving ranking of targets, in accordance with one embodiment.

The server 115a includes a bus 205 or other communication mechanism for communicating information, and a processor 210 coupled with the bus 205 for processing information. The server 115a also includes a memory 215, for example a random access memory (RAM) or other dynamic storage device, coupled to the bus 205 for storing information and instructions to be executed by the processor 210. The memory 215 can be used for storing temporary variables or other intermediate information during execution of instructions by the processor 210. The server 115a further includes a read only memory (ROM) 220 or other static storage device coupled to the bus 205 for storing static information and instructions for the processor 210. A storage device 225, for example a magnetic disk or optical disk, is provided and coupled to the bus 205 for storing information, for example a user connection graph, a list of reviewers, and a reviewer connection graph.

The server 115a can be coupled via the bus 205 to a display 230, for example a cathode ray tube (CRT), and liquid crystal display (LCD) for displaying targets and corresponding rankings to a user. An input device 235, including alphanumeric and other keys, is coupled to bus 205 for communicating information and command selections to the processor 210. Another type of user input device is a cursor control 240, for example a mouse, a trackball, or cursor direction keys for communicating direction information and command selections to the processor 210 and for controlling cursor movement on the display 230. The input device 235 can also be included in the display 230, for example a touch screen. The input device 235 accepts a plurality of instructions for selecting a target. The input device 235 also enables the user to provide one or more rankings to the target. If a new review is provided via the input device 235 then the rankings are recomputed.

Various embodiments are related to the use of server 115a for implementing the techniques described herein. In some embodiments, the techniques are performed by the server 115a in response to the processor 210 executing instructions included in the memory 215. Such instructions can be read into the memory 215 from another machine-readable medium, for example the storage device 225. Execution of the instructions included in the memory 215 causes the processor 210 to perform the process steps described herein.

In some embodiments, the processor 210 can include one or more processing units, for example a user connection unit 250, a reviewer unit 255, and a ranking engine 260, for performing one or more functions of the processor 210. The processing units are hardware circuitry used in place of or in combination with software instructions to perform specified functions.

The user connection unit 250 is used for determining a user connection graph for a plurality of users in a social network. The user connection unit 250 also classifies the users into one or more connection levels based on the user connection graph. The reviewer unit 255 is used for building a list of reviewers associated with each target in the social network. The reviewer unit 255 also determines a reviewer connection graph for the list of reviewers associated with each target. The ranking engine 260 ranks one or more top reviewers, based on the reviewer connection graph, for each target. The ranking engine 260 also specifies an overall rank for each user on the social network. The ranking engine 260 is also used for identifying a principal influencer from the list of reviewers associated with each target. The ranking engine 260 also ranks each target.

The processor 210 is also responsive to the instructions to arrange the list of reviewers associated with each target in a chronological order, to add weights to each target based on the connection levels between each user and the top reviewers, and to update at least one of the user connection graph and the list of reviewers.

In one example, reviewer A and reviewer B belong to the list of reviewers. The reviewer A performs an action by providing a review A for the target at a time A, and the reviewer B performs another action by providing a review B for the target at a time B. The reviewer A will be arranged higher in the chronological order than the reviewer B if the review A at the time A is provided before the review B at the time B, and vice-versa.

The term “machine-readable medium” as used herein refers to any medium that participates in providing data that causes a machine to perform a specific function. In an embodiment implemented using the server 115a, various machine-readable media are involved, for example, in providing instructions to the processor 210 for execution. The machine-readable medium can be a storage medium, either volatile or non-volatile. A volatile medium includes, for example, dynamic memory, such as the memory 215. A non-volatile medium includes, for example, optical or magnetic disks, for example the storage device 225. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic media, a CD-ROM, any other optical media, punchcards, papertape, any other physical media with patterns of holes, a RAM, a PROM, and EPROM, a FLASH-EPROM, any other memory chip or cartridge.

In another embodiment, the machine-readable media can be transmission media including coaxial cables, copper wire and fiber optics, including the wires that comprise the bus 205. Transmission media can also take the form of acoustic or light waves, such as those generated during radio-wave and infra-red data communications. Examples of machine-readable media may include, but are not limited to, a carrier wave as described hereinafter or any other media from which the server 115a can read, for example online software, download links, installation links, and online links. For example, the instructions can initially be carried on a magnetic disk of a remote computer. The remote computer can load the instructions into its dynamic memory and send the instructions over a telephone line using a modem. A modem local to the server 115a can receive the data on the telephone line and use an infra-red transmitter to convert the data to an infra-red signal. An infra-red detector can receive the data carried in the infra-red signal and appropriate circuitry can place the data on the bus 205. The bus 205 carries the data to the memory 215, from which the processor 210 retrieves and executes the instructions. The instructions received by the memory 215 can optionally be stored on the storage device 225 either before or after execution by the processor 210. All such media must be tangible to enable the instructions carried by the media to be detected by a physical mechanism that reads the instructions into a machine.

The server 115a also includes a communication interface 245 coupled to the bus 205. The communication interface 245 provides a two-way data communication coupling to the network 110. For example, the communication interface 245 can be an integrated services digital network (ISDN) card or a modem to provide a data communication connection to a corresponding type of telephone line. As another example, the communication interface 245 can be a local area network (LAN) card to provide a data communication connection to a compatible LAN. Wireless links can also be implemented. In any such implementation, the communication interface 245 sends and receives electrical, electromagnetic or optical signals that carry digital data streams representing various types of information.

The server 115a is also connected to the electronic storage device 120 to store a list of targets.

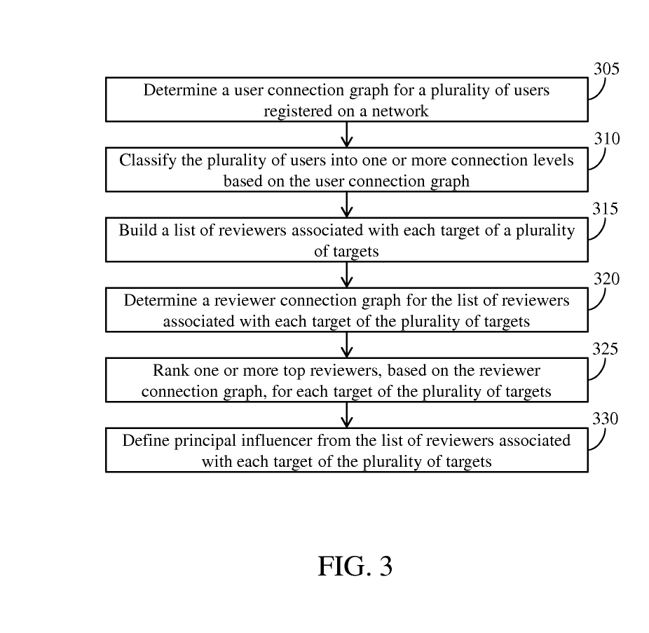

FIG. 3 is a flowchart of a method for identifying a principal influencer in a social network by improving ranking of targets, in accordance with one embodiment.

At step 305, a user connection graph is determined for a plurality of users registered on the social network. The user connection graph is determined by identifying different connections between each user on the social network. The connections are usually established based on social relationships existing among each user on the social network. A set of users having common interests can be connected on the social network.

At step 310, the users are classified into one or more connection levels based on the user connection graph. The connection levels determine proximity of one user to another. The proximity is quantified as number of user connection graph edges traversed. Classification of the users into different connection levels allows weightage of ranks provided for a target to be different for each connection level. In one example, the users on the social network can be classified into two connection levels, a first connection level including friends of a user and a second connection level including friends of each friend of the user.

At step 315, a list of reviewers associated with each target of a plurality of targets is built. The targets are displayed on the social network and each target can be a product or a service. A list of the targets can be stored in an electronic storage device, for example the electronic storage device 120 coupled to the server 115a and the server 115b. Each list of reviewers includes one or more of the users on the social network. Each reviewer in the list of reviewers provides one or more reviews based on one of performance, quality, and service of the target. Each reviewer in the list of reviewers further rank the target based on the performance, the quality, and the service. The reviews for each target enable other users to obtain a thorough knowledge associated with the quality and performance of the target. The reviews further enable one or more of the users to take decisions regarding the target, for example a decision to buy the target.

Further, the target is ranked by the list of reviewers. An average ranking can then be obtained based on connection between a plurality of reviewers in the list of reviewers to a particular user. In one example, a laptop obtains a ranking of 3, 4 and 5 from the list of reviewers. An average ranking of 4 is provided to the laptop. However, if one or more reviewers of the list of reviewers are connected to one user at one of the connection levels, specified in step 310, then the average ranking for the laptop increases for that user. Further, if none of the reviewers in the list of reviewers are connected to the user then the average ranking for the laptop decreases for that user. The ranking of the target (Rt) is a statistical mean of individual rankings and is determined using equation (1) given below:

Rt=Σ(wi*Ri)/Σ(wi) (1)

where wi is probability based weight, and Ri is ranking provided by each user.

wi=Σ(Pi[ ]*FVi[ ]) (2)

where Pi[ ] is a vector of probabilities learnt by a learning layer and self tuned, and FVi[ ] is a feature vector associated with each user, each proximity, and each target based attribute.

The average ranking per reviewer is increased or decreased based on the weightage. The weightage is provided based on the vector of probabilities and feature vectors that are considered.

In some embodiments, the ranking is performed using Pearson's method.

At step 320, a reviewer connection graph is determined for the list of reviewers associated with each target of the plurality of targets. The reviewer connection graph identifies the connections existing among each of the reviewers present in the list of reviewers. In some embodiments, reviewer connection graph edges represent the connections. Upon determining the reviewer connection graph, the reviewers are arranged in a chronological order, for example by date, by year, or by time of reviewing the target. The arrangement of the reviewers in the chronological order helps in identifying a first reviewer of the list of reviewers. The reviewer connection graph can be used to store the chronological order of the reviewers.

At step 325, one or more top reviewers are ranked for each target based on the reviewer connection graph, the chronological order, the weightage, and the feature vector. The top reviewers, in the list of reviewers, associated with each target are first determined and subsequently ranked. One of the top reviewers could be the first reviewer and can be further connected to one or more reviewers present in the list of reviewers.

In some embodiments, each user or reviewer is associated with a corresponding target that is reviewed by the user. The user can provide a ranking to the corresponding target during review. Each user also obtains an individual rank with respect to the corresponding target based on a comparison. Further, based on the individual rank, the weightage and the feature vector, for each reviewer in the list it is identified which reviewer influences other users. In one example, if the user obtains the individual rank as 1 for electronic gadgets, then the user can be referred to as a master of gadgets and can be identified as the principal influencer to one or more users. Such comparison of the user against the target is an offline process and can be performed even if the user is not logged-in to the social network.

In some embodiments, an overall rank is specified for each user. The overall rank is obtained by identifying the individual rank obtained by each user for the corresponding target. The overall rank is obtained based on the targets that are ranked by each user. In one example, if the user has ranked 9 different gadgets and a restaurant on 10 different occasions, then the user obtains a higher individual rank for the gadgets and a lower individual rank for restaurants. The higher individual rank for the gadgets and the lower individual rank for the restaurants are aggregated to obtain the overall rank.

At step 330, the principal influencer is identified from the list of reviewers associated with each target. The principal influencer, in one example, can be the reviewer with highest rank among the list of reviewers and having highest frequency of influencing other users. Further, if the first reviewer is connected to one or more of the other reviewers present in the list of reviewers and the first reviewer is identified to influence maximum number of reviewers in the list, then it can be inferred that the first reviewer is the principal influencer. A number of principal influencers exist for different connection levels. If none of the reviewers are connected, the target has independent principal influencers.

In some embodiments, one or more of the users that are influenced by each reviewer are identified.

In some embodiments, the targets can be grouped based on a set of rules and different lists of reviewers can be merged. The ranking can be determined and the principal influencers for a group of targets are ones having top rankings.

The user connection graph and the list of reviewers can be further updated when a new user registers on the social network or a new reviewer joins the list of reviewers. The new user can then rank the targets. The top reviewers and the overall rank for each user have to be recomputed on updating of the user connection graph and the reviewer connection graph.

In some embodiments, the average ranking of (R1+R2+R3 . . . +Rn)/n is recomputed by first computing weights, for example w1, w2, . . . to wn, and then computing individual rankings. The weightage is provided on computing probabilities based on the different connection levels in the social network.

p1: probability assigned for first connection level

p2: probability assigned for second connection level where p2<p1

p3: probability assigned for third connection level where p3<p2

Each connection level has different number of users, for example N1, N2, N3 . . . Nn. The weightage wi is computed for the ranking using equation (2) and Ri=pj/Nj where Nj is in network j.

The weighted average is then computed to further compute the individual rankings: Ri is ranking provided by each user and wi is an associated weight. Hence, using equation (1),

Rt=Σ(wi*Ri)/Σ(wi)=(R1*1+R2*w2 . . . +Rn*wn)/(w1+w2 . . . +wn) (3)

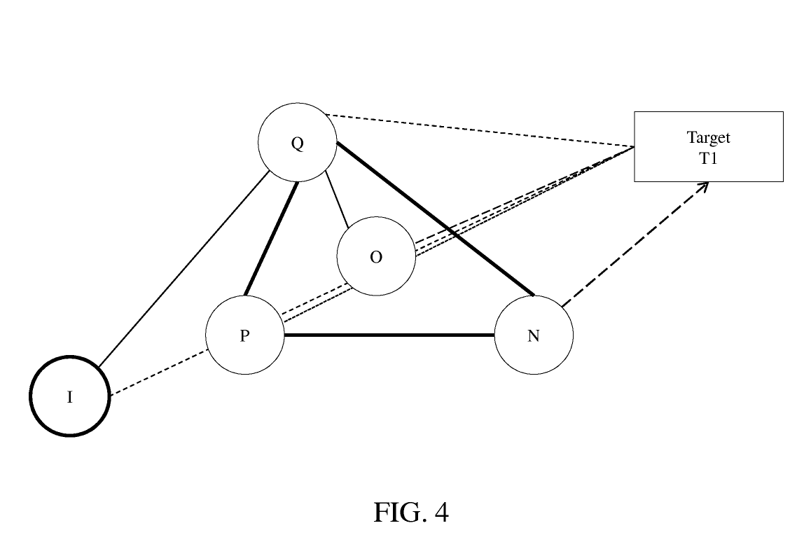

FIG. 4 is an exemplary representation of identification of a principal influencer in a social network, in accordance with one embodiment.

A target T1 in the social network has n reviewers, namely reviewer I, reviewer O, reviewer P, and reviewer Q. The reviewers are connected to each other as shown. Using the method as described in the present disclosure, the ranking is determined by equation (1).

A user N reviews the target T1 and provides a ranking. The ranking is then recomputed for the target T1. Wi is considered along with the chronological order to rank the reviewers for the target T1. The reviewer I and the reviewer P surface as principal influencers for the target T1. The user N can be influenced either by the reviewer Q or the reviewer P. However, the reviewer Q does not have a high individual rank and the reviewer I is not in near proximity to the user N. Hence, the reviewer P is determined to be the principal influencer of the user N.

The present disclosure is enabled using:

1. Application Programming Interfaces (APIs) provided by a platform that creates syndicated digests of user generated content and user activity from content producing properties, made available to content consuming properties. Such syndicated digests can be grouped by users, relationships, subject, or context. In one example, Yahoo® can use Vitality platform.
2. A platform that manages social identity and relationship graph of a user. In one example, Yahoo® can use SocDir API.

The method specified in the present disclosure identifies the principal influencers by improving the ranking of the targets and individual rankings based on the social relationship existing among the users in the social network. The improved ranking enables the users to make decisions associated with the targets. The principal influencers influence the users to take appropriate decisions regarding the targets. The method also enables one or more advertisement servers to identify the principal influencer. The advertisement servers can promote different targets to the principal influencer indirectly marketing the targets to the users.

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example as object code or executable images) within the memory of any programmable computing device.

Accordingly, the disclosure of the present invention is intended to be illustrative, but not limiting, of the scope of the invention, which is set forth in the following claims.

What is claimed is:

1. A method of identifying a principal influencer in a social network by improving ranking of targets, the method comprising:
determining a user connection graph for a plurality of users registered on the social network;
classifying the plurality of users into one or more connection levels based on the user connection graph;
building a list of reviewers associated with each target of a plurality of targets in the social network;
determining a reviewer connection graph for the list of reviewers associated with each target of the plurality of targets;
ranking one or more top reviewers, based on the reviewer connection graph, for each target of the plurality of targets; and
identifying the principal influencer from the list of reviewers associated with each target of the plurality of targets.

2. The method as claimed in claim 1, wherein identifying the principal influencer comprises
identifying one or more of the plurality of users influenced by each reviewer.

3. The method as claimed in claim 1, wherein each target comprises one of a product and a service.

4. The method as claimed in claim 1 and further comprising
ranking each target of the plurality of targets by the list of reviewers.

5. The method as claimed in claim 1 and further comprising
arranging the list of reviewers associated with each target of the plurality of targets in a chronological order.

6. The method as claimed in claim 5 and further comprising
identifying a first reviewer from the list of reviewers.

7. The method as claimed in claim 1 and further comprising
adding weights to each target of the plurality of targets based on the one or more connection levels between each user of the plurality of users and the one or more top reviewers.

8. The method as claimed in claim 1 and further comprising
ranking each user of the plurality of users on the social network for each target.

9. The method as claimed in claim 1 and further comprising
specifying an overall rank for each user of the plurality of users on the social network.

10. The method as claimed in claim 1 and further comprising
updating at least one of the user connection graph and the list of reviewers.

11. A computer program product stored on a non-transitory computer-readable medium that when executed by a processor, performs a method of identifying a principal influencer in a social network by improving ranking of targets, comprising:
determining a user connection graph for a plurality of users registered on the social network;
classifying the plurality of users into one or more connection levels based on the user connection graph;
building a list of reviewers associated with each target of a plurality of targets in the social network;
determining a reviewer connection graph for the list of reviewers associated with each target of the plurality of targets;
ranking one or more top reviewers, based on the reviewer connection graph, for each target of the plurality of targets; and
identifying the principal influencer from the list of reviewers associated with each target of the plurality of targets.

12. The method as claimed in claim 11, wherein identifying the principal influencer comprises
identifying one or more of the plurality of users influenced by each reviewer.

13. The computer program product as claimed in claim 11, wherein each target comprises one of a product and a service.

14. The computer program product as claimed in claim 11 and further comprising
ranking each target of the plurality of targets by the list of reviewers.

15. The computer program product as claimed in claim 11 and further comprising
arranging the list of reviewers associated with each target of the plurality of targets in a chronological order.

16. The computer program product as claimed in claim 15 and further comprising
identifying a first reviewer from the list of reviewers.

17. The computer program product as claimed in claim 11 and further comprising
adding weights to each target of the plurality of targets based on the one or more connection levels between each user of the plurality of users and the one or more top reviewers.

18. The computer program product as claimed in claim 11 and further comprising
ranking each user of the plurality of users on the social network for each target.

19. The computer program product as claimed in claim 11 and further comprising
specifying an overall rank for each user of the plurality of users on the social network.

20. The computer program product as claimed in claim 11 and further comprising
updating at least one of the user connection graph and the list of reviewers.

21. A system for identifying a principal influencer in a social network by improving ranking of targets, the system comprising:
one or more electronic devices;
a communication interface in electronic communication with the one or more electronic devices;
a memory that stores instructions; and
a processor comprising:
a user connection unit responsive to the instructions to
determine a user connection graph for a plurality of users registered on the social network; and
classify the plurality of users into one or more connection levels based on the user connection graph;
a reviewer unit responsive to the instructions to
build a list of reviewers associated with each target of a plurality of targets in the social network; and
determine a reviewer connection graph for the list of reviewers associated with each target of the plurality of targets;
a ranking engine responsive to the instructions to
rank one or more top reviewers, based on the reviewer connection graph, for each target of the plurality of targets;
specify an overall rank for each user of the plurality of users on the social network; and
identify the principal influencer from the list of reviewers associated with each target of the plurality of targets.

22. The system as claimed in claim 21, wherein the processor responsive to the instructions to
arrange the list of reviewers associated with each target of the plurality of targets in a chronological order;
add weights to each target of the plurality of targets based on the one or more connection levels between each user of the plurality of users and the one or more top reviewers; and
update at least one of the user connection graph and the list of reviewers.

23. The system as claimed in claim 21, wherein the ranking engine is further responsive to the instructions to
rank each target of the plurality of targets by the list of reviewers.
